(19) United States
(12) Patent Application Publication
(10) Pub. No.: US 2025/0119391 A1
(43) Pub. Date: Apr. 10, 2025

(54) METHOD, A DEVICE AND A SYSTEM FOR MANAGING INCOMING CALLS

(71) Applicant: Samsung Electronics Co., Ltd., Suwon-si (KR)

(72) Inventors: Himanshu SHARMA, Noida (IN); Sakshi BHATIA, Noida (IN)

(21) Appl. No.: 18/625,681

(22) Filed: Apr. 3, 2024

Related U.S. Application Data
(63) Continuation of application No. PCT/KR2024/095101, filed on Feb. 8, 2024.

(30) Foreign Application Priority Data
Oct. 10, 2023 (IN) 202311067731

(51) Int. Cl. H04L 47/43; H04L 47/34; H04W 72/04

(52) U.S. Cl. CPC H04L 47/43; H04L 47/34; H04W 72/04

(57) ABSTRACT

The disclosure discloses a method and a system for managing incoming calls by sending an actionable notification. The method includes receiving, from a first device, a first call on a second device. The method includes detecting a third device among a plurality of devices to transfer an actionable notification of the first call. The method includes detecting by acknowledgment for an action on the actionable notification from the third device and initiating a second call based on the detected action. The method includes managing, via a conference call, the first call and the second call simultaneously.

### CROSS-REFERENCE TO RELATED APPLICATIONS

This application is a continuation of International Application No. PCT/KR2024/095101 designating the United States, filed on Feb. 8, 2024, in the Korean Intellectual Property Receiving Office and claiming priority to Indian patent application Ser. No. 202311067731, filed on Oct. 10, 2023, in the Indian Patent Office, the disclosures of each of which are incorporated by reference herein in their entireties.

### BACKGROUND

### Field

The disclosure relates to a method, a device and a system for managing incoming calls. For example, the disclosure relates to seamlessly forwarding an incoming call from a caller device to another device by sending an actionable notification.

### Description of Related Art

Call forwarding services are supplementary services that are generally provided in a mobile device. The call forwarding service is a valuable tool for businesses and individuals looking to efficiently manage their incoming calls. By setting up call forwarding, users can redirect incoming calls to a user-defined number, such as their mobile phone or another landline. This feature allows users to stay connected and accessible even when they are away from their mobile phone.

Conventionally, in a call forwarding service, when an incoming call is received, it is automatically rerouted to the user-defined number. This can be done through various methods such as using a mobile phone's settings or accessing a specific call forwarding service provided by a mobile operator. Accordingly, the incoming calls are forwarded to the user-defined numbers so that the incoming calls get attended by respective users associated with the user-defined numbers.

However, the conventional call forwarding services are static in nature. For example, the incoming calls are automatically forwarded to the user-defined number. Such technique of forwarding of the incoming calls is static in nature as the user cannot change a mobile number for forwarding the incoming call in a runtime.

Therefore, there exists a need to address the above-mentioned problems associated with the call forwarding services.

### SUMMARY

According to an example embodiment of the disclosure, a method for managing incoming calls in a called device is disclosed. The method includes receiving, from a first device, a first call on a second device. The method includes detecting a third device among a plurality of devices to transfer an actionable notification of the first call. The method includes detecting by acknowledgment for an action on the actionable notification from the third device and initiating a second call based on the detected action. The method includes managing, via a conference call, the first call and the second call simultaneously.

According to an example embodiment of the disclosure, an apparatus for managing incoming calls in a called device is disclosed. The apparatus includes: at least one processor, comprising processing circuitry, individually and/or collectively configured to receive, from a first device, a first call on a second device, detecting a third device among a plurality of devices to transfer an actionable notification of the first call. At least one processor, individually and/or collectively, is configured to detect by acknowledgment for an action on the actionable notification from the third device and initiate a second call based on the detected action. At least one processor, individually and/or collectively, is configured to manage, via a conference call, the first call, and the second call simultaneously.

According to an example embodiment of the disclosure, a method for managing incoming calls in a called device is disclosed. The method includes receiving, from a second device (B), an actionable notification for a first call originating at a third device (A). The method includes sending an acknowledgment for an action on the actionable notification to the second device (B) and initiating a second call based on the detected action. The method includes managing, via a conference call, the first call, and the second call simultaneously.

According to an example embodiment of the disclosure, an apparatus for managing incoming calls in a called device is disclosed. The apparatus includes at least one processor, comprising processing circuitry, individually and/or collectively configured to receive, from a second device (B), an actionable notification for a first call originating at a third device (A). The one or more processors are configured to send an acknowledgment for an action on the actionable notification to the second device (B) and initiate a second call based on the detected action. At least one processor, individually and/or collectively, is configured to manage, via a conference call, the first call, and the second call simultaneously.

To further clarify advantages and features of the disclosure, a more detailed description will be rendered with reference to various example embodiments thereof, which are illustrated in the appended drawings. It will be appreciated that these drawings depict various example embodiments and are therefore not to be considered limiting its scope. The disclosure and various embodiments will be described and explained with additional specificity and detail with reference to the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, and in which:

FIG. 1 is a diagram illustrating an example working environment for managing the incoming calls, according to various embodiments;

FIG. 2A is a block diagram illustrating an example system architecture of a user device, according to various embodiments;

FIG. 2B is a block diagram illustrating an example configuration of the user device, according to various embodiments;

FIG. 3 is a block diagram illustrating an example configuration of modules/engines of the user device of FIG. 2, according to various embodiments;

FIG. 4 is a block diagram illustrating an example configuration of the notification monitor module, according to various embodiments;

FIG. 5 is a block diagram illustrating an example configuration of the action analyzer module, according to various embodiments;

FIGS. 6A and 6B are block diagrams illustrating example configurations of the nearby call manager module, according to various embodiments;

FIG. 7 is a flow chart illustrating an example method for managing incoming calls, according to various embodiments;

FIG. 8A is a signal flow diagram illustrating an example method for managing incoming calls in a case when the call session with the first device and the second device is continued, according to various embodiments;

FIG. 8B is a signal flow diagram illustrating an example method for managing incoming calls in a case when the call session with the first device and the second device is hung up, according to various embodiments; and

FIG. 9 is a flowchart illustrating an example method implemented in user device in which the incoming call is to be forwarded, according to various embodiments.

FIG. 10 illustrates a structure of a user equipment (UE) according to embodiments of the disclosure.

Further, skilled artisans will appreciate that elements in the drawings are illustrated for simplicity and may not have necessarily been drawn to scale. For example, the flowcharts illustrate methods to help to improve understanding of aspects of the disclosure. Furthermore, in terms of the construction of the device, one or more components of the device may have been represented in the drawings by conventional symbols, and the drawings may show those specific details relevant to understanding embodiments of the disclosure so as not to obscure the drawings with details that will be readily apparent to those of ordinary skill in the art having the benefit of the description herein.

### DETAILED DESCRIPTION

It should be understood at the outset that although various illustrative implementations of various example embodiments of the disclosure are illustrated below, the disclosure may be implemented using any number of techniques, whether currently known or in existence. The disclosure should in no way be limited to the illustrative implementations, drawings, and techniques illustrated below, including the example design and implementation illustrated and described herein, but may be modified within the scope of the disclosure, including the appended claims along with their full scope of equivalents.

The term “some” as used herein may refer, for example, to “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” have a meaning including “no embodiment, or one embodiment, or more than one embodiment, or all embodiments.”

The terminology and structure employed herein is for describing, teaching, and illuminating various example embodiments and their specific features and elements and does not limit, restrict, or reduce the spirit and scope of the claims or their equivalents.

For example, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the disclosure will be described below in greater detail with reference to the accompanying drawings.

According to an embodiment, the disclosure discloses a method and a system for managing incoming calls in a called device. For example, the disclosure is generally directed to a method and the system for seamlessly forwarding an incoming call from a caller device to another device by sending an actionable notification. In an embodiment, the another device may be pre-registered with the called device. According to various embodiments, the another device may be a nearby device to the called device.

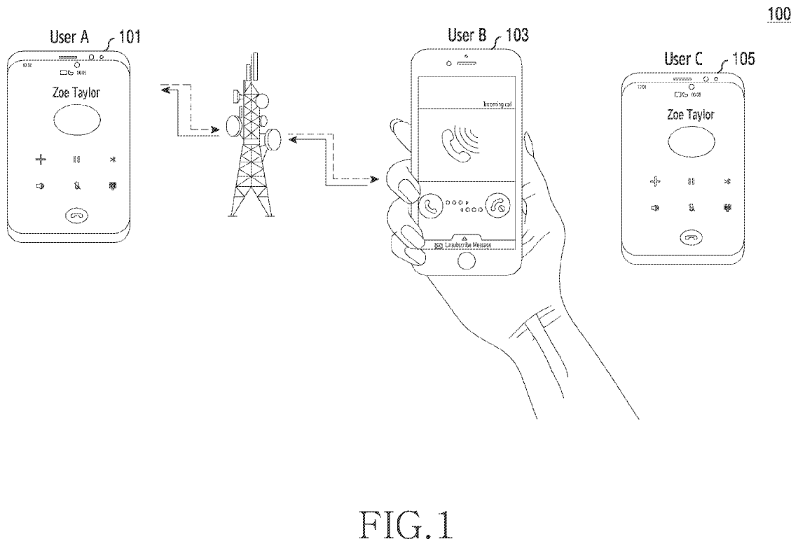

FIG. 1 is a diagram illustrating an example working environment for managing the incoming calls, according to various embodiments. According to an embodiment, consider a scenario where a user A has called user B via his user device 101. However, the user B may be considered as either busy or not present near his user device 103 to attend to an incoming call from the user A. According to an embodiment, when the user B is busy, the user B may select a number from the pre-registered number at runtime to forward the incoming call. As depicted in FIG. 1, the user B has selected a number corresponding to the user device 105 for forwarding the incoming call. According to an embodiment, when the user B is not present near his user device 103 to attend to the incoming call, the user device 103 may detect nearby devices for forwarding the incoming call. In an embodiment, an actionable notification is sent by the user device 103 for forwarding the incoming call. In an embodiment, the actionable notification includes a notification for accepting or rejecting the incoming call along with other parameters associated with the user device 101 and the user device 103.

A more detailed methodology is explained below with reference to the drawings.

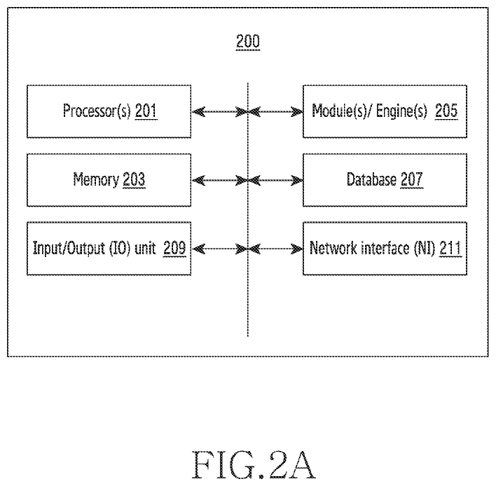

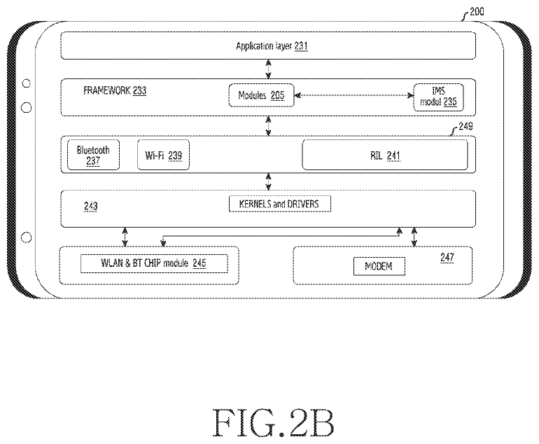

FIG. 2A is a block diagram illustrating an example system architecture of a user device, according to various embodiments. The user device 200 includes a processor(s) (e.g., including processing circuitry) 201, a memory 203, a modules/engines (e.g., including various circuitry and/or executable program instructions) 205, a database 207, an Input/Output (I/O) unit (e.g., including I/O circuitry) 109, and a Network Interface (NI) (e.g., including various circuitry) 211 connected to each other (e.g., via a bus).

As an example, the user device 200 may correspond to various devices such as a mobile device, a smart phone, a communication device, a user equipment (UE), or any other machine capable of executing a set of instructions and capable of establishing a call with another device. In an embodiment, the user device 200 is capable of receiving incoming calls and initiating outgoing calls to another device. As an example, the incoming calls or the outgoing calls may be one of, but not limited to, a Voice over Long Term Evolution (VoLTE) calls or a 5G call. The user device 200 may be interchangeably referred to as the UE, the smartphone, or the mobile device throughout the disclosure.

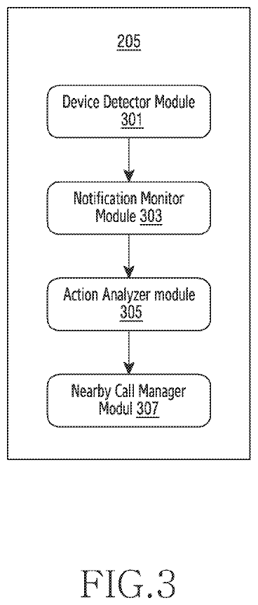

As an example, the processor 201 may be a single processing unit or a number of units, all of which could include multiple computing units. The processor 201 may be implemented as one or more microprocessors, microcomputers, microcontrollers, digital signal processors, central processing units, logical processors, virtual processors, state machines, logic circuitries, application processors, communication processors, and/or any devices that manipulate signals based on operational instructions. Among other capabilities, the processor 201 is configured to fetch and execute computer-readable instructions and data stored in the memory 203. Further, the function of the modules 205 may alternatively be performed using processor 201. The processor 201 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. However, for the ease of understanding, the explanation is made through various modules discussed in in greater detail below with reference to FIG. 3.

The memory 203 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

In an example, the module(s)//engine(s) 205 may include a program, a subroutine, a portion of a program, a software component, and/or a hardware component capable of performing a stated task or function. As used herein, the module(s)/engine(s) 205 may be implemented on a hardware component such as a server independently of other modules, or a module can exist with other modules on the same server, or within the same program. The module(s)/engine(s) 205 may be implemented on a hardware component such as processor one or more microprocessors, microcomputers, microcontrollers, digital signal processors, central processing units, state machines, logic circuitries, and/or any devices that manipulate signals based on operational instructions. The module(s)/engine(s) 205 when executed by the processor(s) 201 may be configured to perform any of the functionalities, as discussed here in the disclosure.

As a further example, the database 207 may be implemented with integrated hardware and software. The hardware may include a hardware disk controller with programmable search capabilities or a software system running on general-purpose hardware. The examples of the database 207 are, but are not limited to, in-memory databases, cloud databases, distributed databases, embedded databases, and the like. The database 207, amongst other things, serves as a repository for storing data processed, received, and generated by one or more of the processors, and the modules/engines/units.

In an embodiment, the module(s)/engine(s) 205 may be implemented using one or more AI modules that may include a plurality of neural network layers. Examples of neural networks include but are not limited to, Convolutional Neural Network (CNN), Deep Neural Network (DNN), Recurrent Neural Network (RNN), Restricted Boltzmann Machine (RBM). The ‘learning’ may be referred to in the disclosure as a method for training a predetermined target device (for example, a robot) using a plurality of learning data to cause, allow, or control the target device to make a determination or prediction. Examples of learning techniques include but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The one or a plurality of processors control the processing of the input data in accordance with a predefined operating rule or Artificial intelligence (AI) model stored in the non-volatile memory and the volatile memory. The predefined operating rule or artificial intelligence model is provided through training or learning.

As an example, an Input/Output (IO) unit 209 may include various I/O circuitry and receives and outputs audio data of multiple users. In a non-limiting example, the IO unit 209 includes a mic, and a speaker to receive and output the audio data respectively. As a further example, the network interface 211 may include various circuitry and establishes a network connection with a network like a home network, a public network, or a private network and the like.

FIG. 2B is a block diagram illustrating an example configuration of the user device, according to various embodiments. As can be seen, the user device 200 includes an application layer 231 implemented with one or more applications. The user device 200 further includes a framework layer 233 implemented with the module 205, and an IP Multimedia Subsystem (IMS) module 235. In an embodiment, the IMS module 235 handles all the incoming calls and outgoing calls. For example, the VoLTE, Wireless Fidelity (WiFi), and the 5G calls. According to an embodiment, the user device 200, a next layer (e.g., an operating system layer 249) of the user device 200 includes system libraries of a Bluetooth 237 and Wi-Fi 239. This layer includes an RIL 241. The RIL is an interface layer between the application processor (AP) and the communication Processor (CP) (e.g., Modem) and is used for all communications between AP and CP. For example, for the outgoing and incoming notification messages and calls on LTE/5G and the like. The user device 200 further includes a layer 243 implemented with kernels and drivers. In addition, the user device 200 may further include WLAN and BT chip module 245 for performing Bluetooth communication and WiFi communication. The user device 200 further includes the Modem 247 for providing messaging services. The modem 247 is CP protocol layer that follows LTE protocol required for the user device 200 for latching with a network and thereby sending or receiving packets to the network.

FIG. 3 is a block diagram illustrating an example configuration of modules/engines of the user device of FIG. 2, according to various embodiments. For example, the module(s)/engine(s) 205 as shown in FIG. 3 may include a device detector module 301, a notification monitor module 303, an action analyzer module 305, and a nearby call manager module 307, each of which may include various circuitry and/or executable program instructions. Each module will be explained in greater detail below.

According to an embodiment, the device detector module 301 detects the nearby device to which the incoming call is required to be forwarded. According to an embodiment, the device detector module 301 detects the user device for forwarding the incoming call. As explained above, the incoming call may be forwarded to the another device when the user is either busy and cannot pick up the incoming call at that given instant or the user is not present near his mobile device to pick up the incoming call. Thus, when the user is busy and cannot pick up the incoming call at that given instant, the user may select a number from the pre-registered number at the runtime to forward the incoming call. According to an embodiment, based on a user input at the runtime, the device detector module 301 detects the another device to forward the incoming call by selecting the another device from a list of devices whose identification numbers (e.g. IMEI number) are pre-register in the user device 200. In the example scenario of FIG. 1, the list of devices is pre-register with the user device B 103 where the device C 105 is pre-register with the user device B 103. In the example scenario of FIG. 1, the incoming call is originated from the user device A 101. Further, the incoming call was made to user device B 103. Furthermore, when the user is busy, the incoming call is forwarded to user device C 105 based on the selection of the user device C 105 at the runtime.

According to an embodiment, when the user is not present near his mobile device to pick up the incoming call that is during an non-answering event of the incoming call, the device detector module 301 detects the another device by performing one or more operations on the list of devices whose identification number (e.g. IMEI number) are pre-register in the user device 200. In an embodiment, the device detector module 301 performs the one or more operations including sending at least one of a first scan request for discovering a nearby Bluetooth (BT) devices, a second scan request for discovering a nearby wireless fidelity (Wi-Fi) devices, or a short message service (SMS) request.

In an embodiment, the device detector module 301 sends an actionable notification to the another device after the detection. In an embodiment, the actionable notification includes the notification for accepting or rejecting the incoming call along with other parameters associated with the user device from which the incoming call is initiated and the user device to which the incoming call is made. Referring back to the example scenario of FIG. 1, the user device from which the incoming call is initiated is the user device A 101, and the user device to which the incoming call is made is the user device B 103. Accordingly, the user device B 103 sends an actionable notification to the user device C 105. In an embodiment, the actionable notification includes at least a caller ID of the user device from which the incoming call is initiated (e.g. the user device A 101), an address of the user device to which the incoming call is made (e.g. the user device B 103), an address of the user device to which the incoming call is to be forwarded (e.g. the user device C 105), a message ID indicating the acknowledgment for accepting or rejecting the incoming call, a response code for the accepting or the rejecting the incoming call. In a further embodiment, the actionable notification is transcoded with a message at the user device to which the incoming call is made (e.g. the user device B 103) which is further sent to the user device to which the incoming call is to be forwarded (e.g. the user device C).

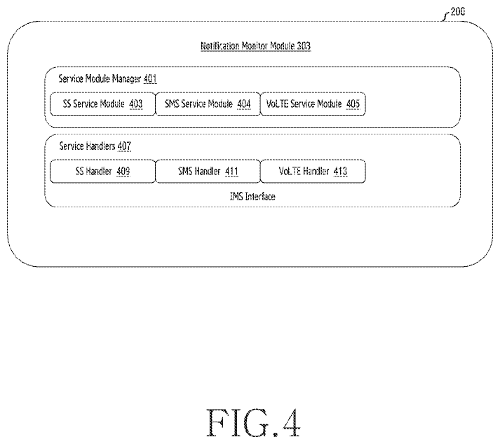

According to an embodiment, the notification monitor module 303 detects an incoming notification. FIG. 4 is a block diagram illustrating an example configuration of the notification monitor module, according to various embodiments. The notification monitor module 303 includes a service module manager 401, and a service handler 407. In an embodiment, the service module manager 401 handles services like Calls, SMS, and supplementary service (SS) via VoLTE service module 405, SMS service module 404, and SS service module 403 respectively. The SS includes Bluetooth (BT) services, Wi-Fi Services, and other communication services. In an embodiment, the service module manager 401 extends the service handler 407. In an embodiment, the service handler 407 includes an SS handler 409 for handling SS services, an SMS handler 411 for handling SMS services, VoLTE handler 413 for handling VoLTE services. Each of the modules may include various circuitry and/or executable program instructions.

In an embodiment, the notification monitor module 303 detects all types of incoming requests. For example, the notification monitor module 303 detects requests related to the first scan request for discovering the nearby BT devices, the second scan request for discovering the nearby Wi-Fi devices, or the SMS request. In an embodiment, the notification monitor module 303 may send an acknowledgment message in response to the incoming request.

In an embodiment, the incoming notification includes receiving actionable notification from the user device to which the incoming call is made (e.g. the user device B 103). Accordingly, the notification monitor module 303 notifies the incoming request (e.g. incoming call) to the action analyzer module 305. In an embodiment, the notification monitor module 303 may send an acknowledgment message in response to the incoming request.

In an embodiment, the action analyzer module 305 detects an action for acceptance or rejection on the incoming call notification sent by the user device to which the incoming call is made (e.g. the user device B 103). In an embodiment, when the actionable notification is sent by the user device to which the incoming call is made (e.g. the user device B 103), the action analyzer module 305 analyses the action performed by the user of the user device to which the incoming call is to be forwarded (e.g. the user device C 105). In particular, the action analyzer module 305 detects based on the acknowledgment for the action on the actionable notification from the user device to which the incoming call is to be forwarded (e.g. the user device C 105). The operation of the action analyzer module 305 in greater detail below.

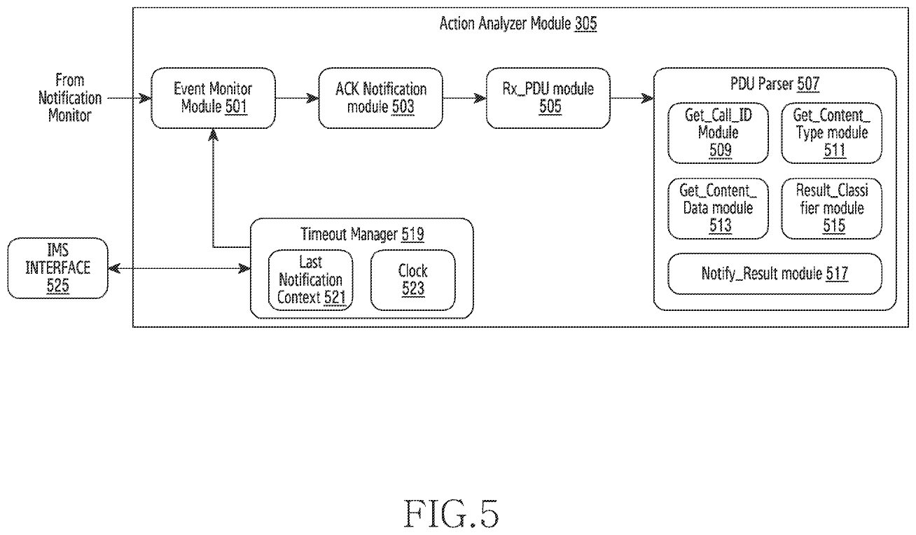

FIG. 5 is a block diagram illustrating an example configuration of the action analyzer module, according to various embodiments. In an embodiment, the action analyzer module 305 includes an event monitor module 501, an ACK notification module 503, an Rx_PDU module 505, a PDU parser 507, and a timeout manager 519. In an embodiment, the action analyzer module 305 receives the notification related to the incoming request for the incoming call from the notification monitor module 303. In an embodiment, the event monitor module 501 monitors a reception of acknowledgment message for the action on the incoming call notifications from the another device. Referring back to FIG. 1, the event monitor module 501 of the user device B 103, monitors the acknowledgment message for the action taken by the respective user of the user device C 105 of the received actionable notification. According to an embodiment, the respective user of the user device to which the incoming call is to be forwarded (e.g. the user device C 105) may accept or reject the incoming call notification. The ACK notification module 503 gets triggered when a notification of the acknowledgment message is received. Thereafter, the RX_PDU module 505 receives via Protocol Data Unit (PDU), the acknowledgment message including a plurality of device parameters and the acknowledgment for the action on the actionable notification. In a non-limiting example, the plurality of device parameters includes at least one of a call identification (ID) or a type of content in the acknowledgment message. Further, the acknowledgment of the action includes accepting or rejecting the incoming call. In a non-limiting example, the call identification (ID) corresponds to an identification of the user device that has sent the notification. Further, in a non-limiting example, the type of content in the acknowledgment message includes content in the acknowledgment message related to an incoming message, or content in the acknowledgment message related to an incoming call.

In an embodiment, the PDU parser 507 parses the acknowledgment message to identify the action of the user and the device parameters. In an embodiment, the PDU parser 507 includes various modules such as a get_call_ID module 509, a get_content_type module 511, get_content_data 513, a result_classifier module 515, and a notify_result module 517. In an embodiment, the get_call_ID module 509 parses and obtains the call ID from the acknowledgment message, the get_content_type module 511 parses and obtains the type of content in the acknowledgment message. The get_content_data module 513 parses and obtains the data in the acknowledgment message. In an example, the data obtained by the get_content_data module 513 includes data like accept or reject message from the another device. In a further embodiment, the result_classifier module 515 analyses the acknowledgment message and classifies the action of accepting or rejecting the incoming call notification. In particular, Thereafter, the notify_result module 517 notifies the result of the acceptance or the rejection to the nearby call manager module 307.

According to a further embodiment, the timeout manager 519 triggers when there is no response for the incoming call from the user device to which the incoming call is to be forwarded (e.g. the user device C 105) for a predefined period of time. The clock 523 monitors an expiry of the predefined period of time. In an embodiment, when there is no response from any of the connected devices, then the nearby call manager module 307 will not be activated. Therefore, the call at user device B 103 from the user device A 101 will be not accepted and established.

In an embodiment, the last notification context 521 of the action analyzer module 305 deactivates the clock 523 when a notification of the acknowledgment message is received. Further, in an embodiment the IMS INTERFACE 525 exposes APIs that are used to manage all the IMS based calls.

According to an embodiment, upon receiving the acknowledgment for accepting the incoming call from the user device to which the incoming call is to be forwarded (e.g. the user device C 105), the nearby call manager module 307 initiates an outgoing call with the user device to which the incoming call is to be forwarded (e.g. the user device C 105) in a condition when a call session with the user device from which the incoming call is initiated (e.g. the user device A 101) and the user device to which the incoming call is made (e.g. the user device B 103) is continued.

According to an embodiment, upon receiving the acknowledgment for accepting the incoming call from the user device to which the incoming call is to be forwarded (e.g. the user device C 105), the nearby call manager module 307 initiates the outgoing call with both user devices to which the incoming call is to be forwarded (e.g. the user device C 105) and the user device from which the incoming call is initiated (e.g. the user device A 101) in a condition when the call session with the user device from which the incoming call is initiated (e.g. the user device A 101) and the user device to which the incoming call is made (e.g. the user device B 103) is hung up. The working of the nearby call manager module 307 through various components will be described in greater detail below.

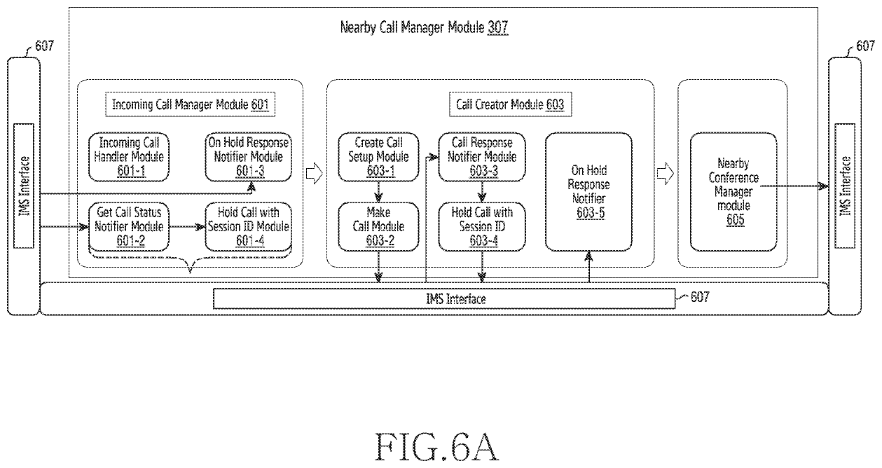

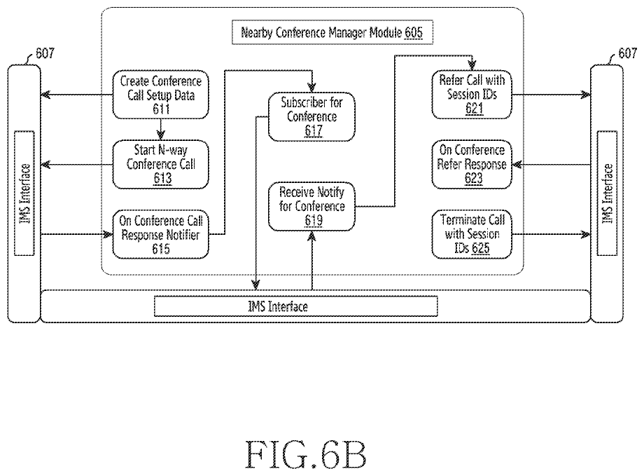

FIGS. 6A and 6B are block diagrams illustrating example configurations of the nearby call manager module, according to various embodiments. In an embodiment, the nearby call manager module 307 includes an incoming call manager module 601, a call creator module 603, and a nearby conference manager module 605, each of which include various circuitry and/or executable program instructions which may be in the form of further modules. According to an embodiment, the incoming call manager module 601 based on the result of the action analyzer module 305 accepts the incoming call using the IMS interface 607. Referring to the example of FIG. 1, the incoming call manager module 601 of the user device to which the incoming call is to be forwarded (e.g. the user device C 105) accepts the incoming call. According to an embodiment, the incoming call manager module 601 includes an incoming call handler module 601-1, a get call status notifier module 601-2, an on hold response notifier module 601-3, a hold call with session ID module 601-4. Accordingly, the incoming call handler module 601-1 handles the incoming calls using IMS interface 607. The get call status notifier module 601-2 obtains a current status of the incoming call. In an embodiment, in case the call status is established, the hold call with session ID module 601-4 sends a request to hold the current ongoing call to the user device A 101. Further, the on hold response notifier module 601-3 receives a notification once the incoming call is held successfully. In an example scenario of FIG. 1, consider that the user device C 105 accepts the incoming call and the call is established. Thus, upon successfully establishing the incoming call, the incoming call manager 601 of the user device B 103 holds the incoming call with the user device A for a very short predefined time period.

In an embodiment, after holding the incoming call, the call creator module 603 creates a new outgoing call session for the user device to which the incoming call is to be forwarded (e.g. the user device C 105) which is detected through the action analyzer module 305. Accordingly, the call creator module 603 of the user device to which the incoming call is made (e.g. the user device B 103) sends a new call invite to the user device to which the incoming call is to be forwarded (e.g. the user device C 105). Once the notification for the call established is received the call creator module 603 of the user device to which the incoming call is made (e.g. the user device B 103) sends a request to hold the incoming call with the user device to which the incoming call is to be forwarded (e.g. the user device C 105). Accordingly, once both the incoming and the outgoing calls are on hold, a conference call was set up by merging the incoming and the outgoing calls simultaneously.

In an embodiment, the call creator module 603 includes a create call set data module 603-1 and a make call module 603-2 for creating the new outgoing call session and making the call with the user device to which the incoming call is to be forwarded (e.g. the user device C 105). The outgoing call is established with the user device to which the incoming call is to be forwarded (e.g. the user device C 105) in a condition when the call session with the user device from which the incoming call is initiated (e.g. the user device A 101) and the user device to which the incoming call is made (e.g. the user device B 103) is continued. Further, the call creator module 603 includes a call response notifier module 603-3 for receiving a notification for the establishment of the call. The hold call with session ID module 603-4 holds the outgoing call with the user device to which the incoming call is to be forwarded (e.g. the user device C 105). Thus, after holding both the incoming and the outgoing call, the on hold response notifier 603-5 sends the notification related to the holding of the both the incoming and the outgoing call to the nearby conference manager module 605.

According to an embodiment, the call creator module 603 creates a new outgoing call session with both the user device from which the incoming call is initiated (e.g. the user device A 101), and the user device to which the incoming call is to be forwarded (e.g. the user device C 105) in the condition when the call session with the user device from which the incoming call is initiated (e.g. the user device A 101), and the user device to which the incoming call is made (e.g. the user device B 103) is hung up. The working of various components will be the same as or similar to those explained above.

In an embodiment, the nearby conference manager module 605, creates a conference by sending an INVITE request with a conference factory Uniform Resource Indicator (URI) for a three-way session to an operator conference server, when both calls are on hold successfully. The conference factory URI is a unique Session Initiation Protocol (SIP) address of the operator conference server. In an embodiment, the create conference call setup data 611 and the start N-way conference call 613 creates a conference and sends the INVITE request respectively. In particular, the create conference call setup data 611 creates the data used to setup conference call using IMS Interface. In a non-limiting example, the data includes at least the conference factory URI, a type of the incoming Call (e.g., voice call or video call), a device's mobile station integrated services digital network (MSISDN), audio/video codecs and the like.

In an embodiment, the on conference call response notifier 615 receives a status of establishment of the conference call. In a further embodiment, the subscriber for conference 617 subscribes to the conference event package. Further, the receive notify for conference 619 receives the notification when the conference call is terminated. In a further embodiment, the refer call with session IDs 621 sends a refer request for the held session IDs. In a further embodiment, once the conference call is created and established successfully through on conference call refer response 623, the nearby call module manager 307 of the user device to which the incoming call is made (e.g. the user device B 103) releases the active session with the user device from which the incoming call is initiated (e.g. the user device A 101), and the user device to which the incoming call is to be forwarded (e.g. the user device C 105). That is a terminate call with session IDs 625 terminates the session ID of the nearby conference manager module 605 terminates the call session with user device A 101 and the user device 105.

According to an embodiment, the various components of the module 205 as explained through FIGS. 3 to 6B are interchangeably performed by the user device from which the incoming call is initiated, the user device to which the incoming call is made, and the user device to which the incoming call is to be forwarded are per their required operations during the managing of the incoming call.

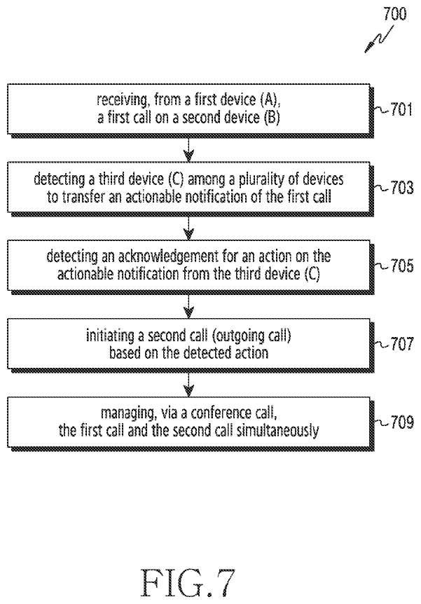

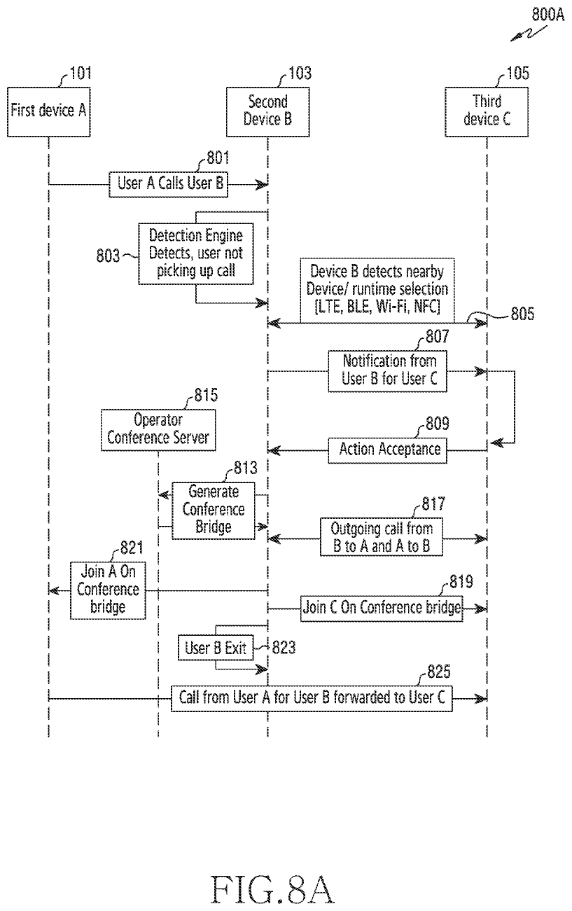

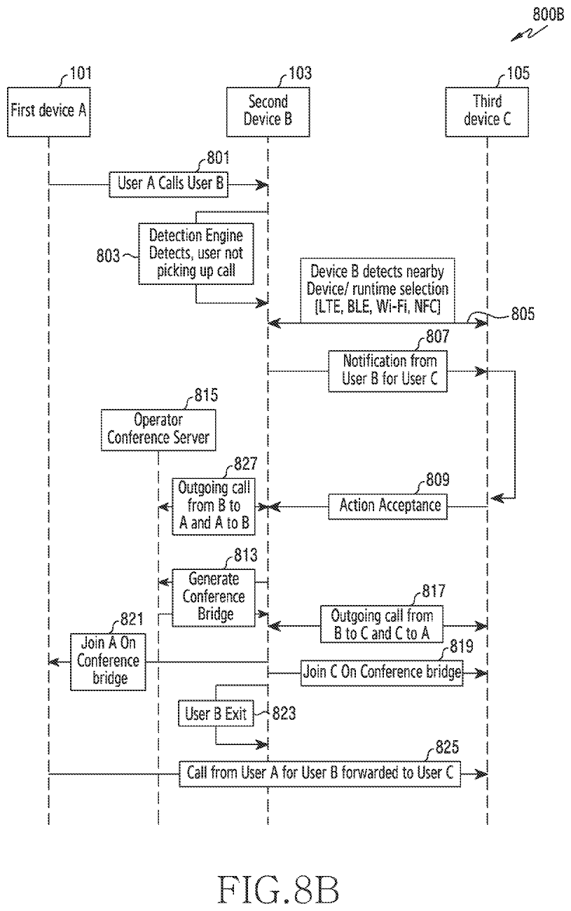

FIG. 7 is a flowchart 700 illustrating an example method for managing incoming calls, according to various embodiments. FIG. 8A is a signal flow diagram illustrating an example operation flow 800A for managing incoming calls in a case when the call session with the first device and the second device is continued, according to various embodiments. FIG. 8B is a signal flow diagram illustrating an example operation flow 800B for managing incoming calls in a case when the call session with the first device and the second device is hung up according to various embodiments. The method 700 will be explained collectively with operations 800A and 800B for ease of understanding. In an embodiment, the method 700 is implemented in the user device 200 of FIG. 2 through modules 205. In an embodiment, as depicted in the operation flow 800A, a first device A 101 is the user device from which the incoming call is initiated (e.g. the user device A 101), a second device B 103 is the user device to which the incoming call is made (e.g. the user device B 103), and a third device C is the user device to which the incoming call is to be forwarded (e.g. the user device C 105). Accordingly, for the ease of understanding the reference numerals have been kept the same. In an embodiment, the method 700 is implemented in a second device B. A detailed explanation of the module 205 has been explained above through FIGS. 2 to 6B therefore detailed explanation of the same may not be repeated here.

At step 701 receiving, from a first device A 101, the incoming call on a second device B 103. The step 701 corresponds to step 801 of FIG. 8A. Now in case the user is unavailable to pick up the call or is busy, at step 703, the second device B 103 detects a third device C 105 among one or more devices to transfer an actionable notification of the incoming call. Thus, the second device B 103 performs the detection of the third device among the plurality of devices based on one of a user input at the runtime or the non-answering event of the incoming call. The non-answering event occurs when the user is absent near the second device B 103. Further, it is to be assumed that second device B 103 initially performed the pre-registering of the one or more devices with the second device 103 based on the user input. The step 703 corresponds to the step 803 of FIG. 8A.

In an embodiment, the second device B 103 detects the third device C 105 either by performing one or more operations or by selecting the third device C 103 at the run time. According to an embodiment, in the non-answering event of the incoming call, the detection of the third device C among the one or more devices includes performing a plurality of operations including sending at least one of a first scan requests for discovering a nearby Bluetooth (BT) devices, a second scan request for discovering a nearby wireless fidelity (Wi-Fi) devices, or a short message service (SMS) request. The plurality of operation is performed at step 805 of FIG. 8A. Thus, After performing the one or more operations, the third device C 105 receives a response corresponding to at least one of the first scan requests, the second scan request, and the SMS request. Accordingly, the second device B 103 detects the third device C 105 based on the response. In an embodiment, the response includes at least one of the device identification (ID), the device type, signal strength information, device capability information, available service information, and the like. In the example embodiment, consider that the response is received from the third device C 105.

According to various embodiments, the user of the second device B 103 selects the third device C 105 at runtime in case the user is busy for picking up the call.

According to an embodiment, at step 807 of FIG. 8A, after the detection of the third device C 105, the second device B 103 sends an actionable notification for accepting or rejecting the incoming call to the third device C 105. Thus, the steps 803, 805, and 807 collectively corresponds to the step 703.

At step 705, the second device B 103 detects the acknowledgment for the action on the actionable notification from the third device C 105. In an embodiment, the action by the third device C 105 may include accepting or rejecting the incoming call. In an embodiment, consider that the third device C 105 accepts the incoming call. Accordingly, the third device C 105 sends an acknowledgement for accepting the incoming call to the second device B 103. The step 705 corresponds to the step 809.

Upon accepting the incoming call by the third device C 105, at step 707, the second device B initiates the outgoing call with the third device C 105. In the similar way, the third device C 105 initiates the outgoing call with the second device B 103. The step 817 is similar to the step 707. Thereafter, the second device B 103 generates a conference bridge via an operator conference server 815. In the meantime, the outgoing call between the second device B 103, and the third device C 105 are kept on hold.

According to the example scenario of operation method 800A, it is considered that while performing the above operations by the second device B 103, the call session between the second device B 103 and the first device C 101 is in continuation.

Further, according to the example scenario of operation method 800B, it is considered that while performing the above operations by the second device B 103, the call session between the second device B 103 and the first device C 101 is hung up. In such a scenario the outgoing call is initiated for both the first device A 101 and the third device C 105 as shown in steps 817 and 827 of FIG. 8B. The reference numerals in FIG. 8B have been kept same with FIG. 8A as the steps are analogous to each other and for the ease of understanding.

Referring back to FIG. 8A, after generating the conference bridge via an operator conference server 815 at step 813, the second device B 103 joins with the third device C 105 at step 819 and the first device at step 821 by merging the incoming call and the outgoing call. At step. Accordingly, at step 709, the second device B 103 managing, via the conference call, the incoming call and the outgoing call simultaneously. Thereafter, at step 825, the call from the first device A 101 is forwarded to the third device C 103 via conference call. In the meantime, the second device B 103 exit at step 823 by releasing its active call sessions with the third device C 105 and the first device A.

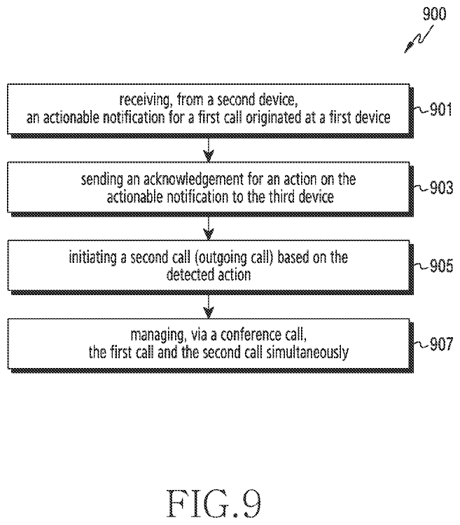

FIG. 9 is a flowchart illustrating an example method 900 implemented in the third device C 105 according to various embodiments. In an embodiment, the implementation of the method 900 can be envisaged from the description of the methods 700, 800A and 800B, therefore for the sake of brevity same may not be repeated here in detail.

At step 901 receiving at the third device C 105, from the second device B 103, the actionable notification for the incoming call originated at the first device A 101. The step 901 corresponds to the step 807. Thereafter, at step 903, the third device C 105 sends the acknowledgement for the action on the actionable notification to the third device C 105. Thereafter, at step 905, the third device C 105 initiating the outgoing call based on the detected action. Thereafter, at step 907, the third device C 105 managing, via the conference call, the incoming call call and the outgoing call simultaneously. The disclosed techniques thus provides a unique method for managing the call via setting up the conference call. Thus, the disclosed method seamlessly transfers the Vo-LTE/5G Calls to the selected contacts on runtime.

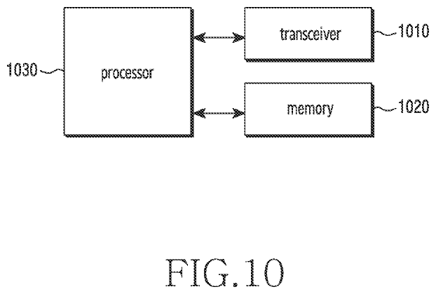

FIG. 10 illustrates a structure of a user equipment (UE) or a device according to embodiments of the disclosure.

As shown in FIG. 10, the UE according to an embodiment may include a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor. Furthermore, the UE of FIG. 10 corresponds to the device of the FIG. 2A.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by another UE, an entity or a device. The UE of FIG. 10 corresponds to a device, an entity, a module or the like.

In various embodiments, a method for managing incoming calls, the method comprising: receiving, from a first device, a first call on a second device; detecting a third device among a plurality of devices to transfer an actionable notification of the first call; detecting an acknowledgement for an action on the actionable notification from the third device; initiating a second call based on the detected action; and managing, via a conference call, the first call and the second call simultaneously.

Preferably, wherein detecting the third device among the plurality of devices is based on one of an input at a runtime or a non-answering event of the incoming call.

Preferably, wherein based on the non-answering event of the incoming call, the detection of the third device among the plurality of devices comprises: performing a plurality of operations including sending at least one of a first scan request for discovering a nearby Bluetooth (BT) device, a second scan request for discovering a nearby wireless fidelity (Wi-Fi) device, or a short message service (SMS) request; receiving a response corresponding to at least one of the first scan request, the second scan request, and the SMS request; and detecting the third device among the plurality of the devices based on reception of the response corresponding to at least one of the first scan request, the second scan request, and the SMS request, wherein the response includes at least one of a device identification (ID), a device type, signal strength information, device capability information, available service information.

Preferably, wherein based on the input at the runtime the detection of the third device among the plurality of devices comprises: selecting in a runtime, via the input, the third device among the plurality of devices that are pre-registered.

Preferably, wherein the actionable notification includes: at least a caller ID of the first device, an address of the second device, an address of the third device, a message ID indicating the acknowledgement for accepting or rejecting the first call, a response code for the accepting or the rejecting the first call, wherein the actionable notification is transcoded with a message sent to the third device.

Preferably, wherein detecting by the acknowledgement for the action on the actionable notification from the third device comprises: monitoring, by the second device, a reception of an acknowledgement message from the third device for the action on the actionable notification, wherein the action by the third device includes accepting or rejecting the first call; and receiving, via Protocol Data Unit (PDU), the acknowledgement message including a plurality of device parameters and the acknowledgement for the action on the actionable notification, wherein the plurality of device parameters includes at least one of a call identification (ID) or a type of content in the acknowledgement message, wherein the acknowledgement for the action includes accepting or rejecting the first call.

Preferably, wherein based on receiving the acknowledgement for accepting the first call from the third device, the second call is initiated with one of: the third device in a condition corresponding to a call session with the first device and the second device is continued, or both the third device and the first device in the condition corresponding to the call session with the first device and the second device is hung up.

Preferably, the method further comprising: holding, based on receiving the acknowledgement for accepting the first call from the third device, the first call and the second call for a specified period of time.

Preferably, wherein managing, via the conference call, the first call and the second call simultaneously comprises establishing the conference call between the first device, the second device, and the third device.

Preferably, the method further comprising: pre-registering the plurality of devices with the second device based on an input, wherein the plurality of operations is performed on the pre-registered plurality of devices.

Preferably, wherein the non-answering event of the incoming call by the second device is based on a condition corresponding to an absence of a user near the second device.

In various embodiment, a method for managing incoming calls at a first device, the method comprising: receiving, from a second device, an actionable notification for a first call originated at a third device; sending an acknowledgement for an action on the actionable notification to the second device, initiating a second call based on the detected action; and managing, via a conference call, the first call and the second call simultaneously.

Preferably, wherein the actionable notification includes one of accepting or rejecting the first call.

Preferably, the method further comprising: receiving at least one of a first scan request for discovering a nearby Bluetooth (BT) device, a second scan request for discovering a nearby wireless fidelity (Wi-Fi) device, or a short message service (SMS) request; and sending a response corresponding to at least one of the first scan request, the second scan request, and the SMS request,
wherein the response includes at least one of a device identification (ID), a device type, signal strength information, device capability information, available service information.

Preferably, wherein the actionable notification is received from second device based on occurrence of an event at the second device, wherein the occurrence of the event at the second device includes receiving an input at runtime or a non-answering event of the incoming call at the second device.

Preferably, wherein the actionable notification includes at least a caller ID of the third device, an address of the first deice, a message ID indicating the acknowledgement for accepting or rejecting the first call, a response code for the accepting or the rejecting the first call, wherein the actionable notification is transcoded with a message received from the second device.

Preferably, the method further comprising: sending an acknowledgement message for the action on the actionable notification, wherein the action includes accepting or rejecting the first call, wherein the acknowledgement message includes a plurality of device parameters and the acknowledgement for the action on the actionable notification, and wherein the plurality of device parameters includes at least one of a call identification (ID) or a type of content in the acknowledgement message, wherein the acknowledgement for the action includes accepting or rejecting the first call.

Preferably, wherein the second call is initiated with: the second device in a condition corresponding to a call session with the second device and the third device is continued.

Preferably, the method further comprising: holding the first call and the second call for a specified period of time upon initiation of the second call.

Preferably, wherein managing, via the conference call, the first call and the second call simultaneously comprises establishing the conference call between with the second device, the third device, and the first device.

Preferably, wherein the first device is pre-registered with second device.

Preferably, wherein the non-answering event of the incoming call by the second device is based on a condition corresponding to an absence of the user near the second device.

In various embodiments, an user device for managing incoming calls, the user device comprising: a memory, communication circuitry and at least one processor, comprising processing circuitry, individually and/or collectively, configured to: receive a first call; detect a first device among a plurality of devices to transfer an actionable notification of the first call; detecting an acknowledgement for an action on the actionable notification from the third device; initiate a second call based on the detected action; and manage, via a conference call, the first call and the second call simultaneously.

In various embodiments, an user device for managing incoming calls, the user device comprising: a memory, communication circuitry and at least one processor, comprising processing circuitry, individually and/or collectively, configured to: receive an actionable notification for a first call originated at a first device; send an acknowledgement for an action on the actionable notification to a second device; initiate a second call based on the detected action; and manage, via a conference call, the first call and the second call simultaneously.

While specific language has been used to describe the disclosure, any limitations arising on account of the same are not intended. As would be apparent to one skilled in the art, various working modifications may be made to the method in order to implement the concept as taught herein.

The drawings and the forgoing description give examples of embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to various embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method performed by a transmitter for handling segmentation in a wireless communication network, the method comprising:
receiving, by an upper layer of a transmitter, a plurality of service data units (SDUs);
concatenating, by a converged L2 of the transmitter, plurality of SDUs received from the upper layer to obtain a protocol data unit (PDU);
assigning, by the converged L2 of the transmitter, a L2 sequence number (SN) to the PDU, wherein the L2 SN includes at least one of a last SDU indicator (LSI) indicating a presence of a last SDU of a complete PDU, a length indicator exist (LIE) indicating a presence of a length indicator (LI) after a L2 header, or a segment indication (SI) indicating a segmentation status or stage of the complete PDU;
receiving, by a medium access control (MAC) layer of the transmitter, a grant opportunity or a transmission opportunity for transferring the PDU available at the converged L2; and
sending, by the MAC layer of the transmitter, the PDU to a lower layer of the transmitter for transmission to a receiver with or without segmentation based on the grant or a transmission opportunity.

2. The method of claim 1, wherein the sending, by the MAC layer of the transmitter, of the PDU to the lower layer of the transmitter for transmission to the receiver with or without segmentation based on the grant opportunity or the transmission opportunity comprises:
determining, by the MAC layer of the transmitter, whether the grant opportunity or the transmission opportunity is enough to send a complete PDU to the receiver; and
performing, by the MAC layer of the transmitter, one of:
sending the complete PDU to a lower layer of the transmitter for transmission to the receiver without segmentation based on the grant opportunity or the transmission opportunity, when the grant opportunity is enough to send the complete PDU,
segmenting the complete PDU into a plurality of PDU segments based on the grant opportunity or the transmission opportunity, or
sending the plurality of PDU segments to a lower layer of the transmitter for transmission to the receiver, when the grant opportunity or the transmission opportunity is not enough to send the complete PDU.

3. The method of claim 2, wherein the sending of the plurality of PDU segments to a lower layer of the transmitter for transmission to the receiver comprises:
creating, by the MAC layer of the transmitter, a segment header for each PDU segment of the plurality of PDU segments based on the grant opportunity or the transmission opportunity;
assigning by the MAC layer of the transmitter, an identifier field with a same L2 SN to each PDU segment in the segment header,
wherein the L2 SN includes a segmentation offset (SO) field, and
wherein the SO field indicates offset from a first byte of a payload, creating, by the MAC layer of the transmitter, a MAC PDU by assigning a MAC sub header to the plurality of PDU segments of the complete PDU; and
sending by the MAC layer of the transmitter, the MAC PDU to the lower layer of the transmitter for transmission to the receiver.

4. The method of claim 3, wherein the sending by the MAC layer of the transmitter, of the MAC PDU to the lower layer of the transmitter for transmission to the receiver comprises:
determining, by the MAC layer of the transmitter, whether the grant opportunity or the transmission opportunity is enough to send an original LI in transmission time intervals (TTIs); and
performing, by the MAC layer, one of:
sending the original LI in all payloads of the PDU segments of the MAC PDU in subsequent TTIs, when the grant opportunity or the transmission opportunity is enough to send the original LI in the subsequent TTIs, or
sending the truncated LI only for a portion of the SDU which is present in the PDU segments of the MAC PDU after segmentation.

5. The method of claim 3, wherein, when the identifier field for the PDU segments in a same L2 Header, the same L2 SN is assigned for all the PDU segments of the complete PDU.

6. The method of claim 2, wherein the sending of the complete PDU to the lower layer of the transmitter for transmission to the receiver without segmentation based on the grant opportunity or the transmission opportunity comprises:
creating, by the MAC layer of the transmitter, a MAC PDU by assigning a SI indicating that the complete PDU is not segmented, an LSI indicating that the complete PDU includes the last SDU which was concatenated to form by the completed PDU at the converged L2, and a LIE indicating a presence of a length Indicator as a L2 Sub Header including an LI field for the plurality of SDUs; and
sending by the MAC layer of the transmitter, the MAC PDU to the lower layer of the transmitter for transmission to the receiver.

7. The method of claim 1, wherein the LSI is set high when the SI indicates the last SDU of the complete PDU.

8. The method of claim 1, wherein the LIE is set high when the LI exist following the L2 Header.

9. The method of claim 1,
wherein the concatenation of the plurality of SDUs to form a complete PDU is done in non-real time (NTR), and
wherein the segmentation is performed in real time (RT) by a layer between the converged L2 and the MAC layer or by a MAC layer using same SN as a packet at converged Layer 2 or a new identifier at MAC layer or a new layer between the converged L2 and MAC layer.

10. A transmitter for handling segmentation in a wireless communication network, the transmitter comprising:
a transceiver;
a processor; and memory storing instructions that, when executed by the processor, cause the transmitter to:
receive a plurality of service data units (SDUs) using an upper layer of the transmitter,
concatenate plurality of SDUs received from the upper layer to obtain a protocol data unit (PDU) using a converged L2 of the transmitter,
assign a L2 sequence number (SN) to the PDU using the converged L2 of the transmitter, wherein the L2 SN includes at least one of a last SDU indicator (LSI) indicating a presence of a last SDU of a complete PDU, a length indicator exist (LIE) indicating a presence of a length indicator (LI) after a L2 header, or a segment indication (SI) indicating a segmentation status or stage of the complete PDU,
receive a grant opportunity or a transmission opportunity for transferring the PDU available at the converged L2 using a medium access control (MAC) layer of the transmitter, and
send the PDU to a lower layer of the transmitter for transmission to a receiver with or without segmentation based on the grant or a transmission opportunity using the MAC layer of the transmitter.

11. The transmitter of claim 10, wherein, to send the PDU to the lower layer of the transmitter for transmission to the receiver with or without segmentation based on the grant opportunity or the transmission opportunity using the MAC layer of the transmitter, the memory further comprises the instructions that, when executed by the processor, cause the transmitter to:
determine whether the grant opportunity or the transmission opportunity is enough to send a complete PDU to the receiver using the MAC layer of the transmitter; and
perform, using the MAC layer of the transmitter, one of:
send the complete PDU to a lower layer of the transmitter for transmission to the receiver without segmentation based on the grant opportunity or the transmission opportunity, when the grant opportunity is enough to send the complete PDU, or
segment the complete PDU into a plurality of PDU segments based on the grant opportunity or the transmission opportunity, and sending the plurality of PDU segments to a lower layer of the transmitter for transmission to the receiver, when the grant opportunity or the transmission opportunity is not enough to send the complete PDU.

12. The transmitter of claim 11, wherein, to send the plurality of PDU segments to a lower layer of the transmitter for transmission to the receiver, the memory further comprises the instructions that, when executed by the processor, cause the transmitter to:
create a segment header for each PDU segment of the plurality of PDU segments based on the grant opportunity or the transmission opportunity using the MAC layer of the transmitter,
assign an identifier field with a same L2 SN to each PDU segment in the segment header using the MAC layer of the transmitter, wherein the L2 SN includes a segmentation offset (SO) field, wherein the SO field indicates offset from a first byte of a payload,
create a MAC PDU by assigning a MAC sub header to the plurality of PDU segments of the complete PDU using the MAC layer of the transmitter, and
send the MAC PDU to the lower layer of the transmitter for transmission to the receiver using the MAC layer of the transmitter.

13. The transmitter of claim 12, wherein, to send the MAC PDU to the lower layer of the transmitter for transmission to the receiver using the MAC layer of the transmitter, the memory further comprises the instructions that, when executed by the processor, cause the transmitter to:
determine whether the grant opportunity or the transmission opportunity is enough to send an original LI in transmission time intervals (TTIs) using the MAC layer of the transmitter; and
perform, using the MAC layer of the transmitter, one of:
send the original LI in all payloads of the PDU segments of the MAC PDU in subsequent TTIs, when the grant opportunity or the transmission opportunity is enough to send the original LI in the subsequent TTIs, or
send the truncated LI only for a portion of the SDU which is present in the PDU segments of the MAC PDU after segmentation.

14. The transmitter of claim 12, wherein the identifier field for the PDU segments in a same L2 Header, the same L2 SN is assigned for all the PDU segments of the complete PDU.

15. The transmitter of claim 11, wherein, to send the complete PDU to the lower layer of the transmitter for transmission to the receiver without segmentation based on the grant opportunity or the transmission opportunity, the memory further comprises the instructions that, when executed by the processor, cause the transmitter to:
create a MAC PDU by assigning a SI indicating that the complete PDU is not segmented, an LSI indicating that the complete PDU includes:
the last SDU which was concatenated to form by the completed PDU at the converged L2, and
a LIE indicating a presence of a length Indicator as a L2 Sub Header including an LI field for the plurality of SDUs using the MAC layer of the transmitter; and
send the MAC PDU to the lower layer of the transmitter for transmission to the receiver using the MAC layer of the transmitter.

16. The transmitter of claim 10, wherein the LSI is set high when the SI indicates the last SDU of the complete PDU.

17. The transmitter of claim 10, wherein the LIE is set high when the LI exist following the L2 Header.

18. The transmitter of claim 10,
wherein the concatenation of the plurality of SDUs to form a complete PDU is done in non-real time (NTR), and
wherein the segmentation is performed in real time (RT) by a layer between the converged L2 and the MAC layer or by a MAC layer using same SN as a packet at converged Layer 2 or a new identifier at MAC layer or a new layer between the converged L2 and MAC layer.

19. A non-transitory computer-readable recording medium storing a program including instructions that, when executed by a processors of a transmitter, cause the transmitter to perform operations comprising:
receiving, by an upper layer of a transmitter, a plurality of service data units (SDUs);
concatenating, by a converged L2 of the transmitter, plurality of SDUs received from the upper layer to obtain a protocol data unit (PDU);
assigning, by the converged L2 of the transmitter, a L2 sequence number (SN) to the PDU, wherein the L2 SN includes at least one of a last SDU indicator (LSI) indicating a presence of a last SDU of complete PDU, a length indicator exist (LIE) indicating a presence of a length indicator (LI) after a L2 header, or a segment indication (SI) indicating a segmentation status or stage of the complete PDU;
receiving, by a medium access control (MAC) layer of the transmitter, a grant opportunity or a transmission opportunity for transferring the PDU available at the converged L2; and
sending, by the MAC layer of the transmitter, the PDU to a lower layer of the transmitter for transmission to a receiver with or without segmentation based on the grant or a transmission opportunity.

20. The non-transitory computer-readable recording medium of claim 19, wherein the sending, by the MAC layer of the transmitter, of the PDU to the lower layer of the transmitter for transmission to the receiver with or without segmentation based on the grant opportunity or the transmission opportunity comprises:
determining, by the MAC layer of the transmitter, whether the grant opportunity or the transmission opportunity is enough to send a complete PDU to the receiver; and
performing, by the MAC layer of the transmitter, one of:
sending the complete PDU to a lower layer of the transmitter for transmission to the receiver without segmentation based on the grant opportunity or the transmission opportunity, when the grant opportunity is enough to send the complete PDU,
segmenting the complete PDU into a plurality of PDU segments based on the grant opportunity or the transmission opportunity, or
sending the plurality of PDU segments to a lower layer of the transmitter for transmission to the receiver, when the grant opportunity or the transmission opportunity is not enough to send the complete PDU.
